(19) United States
(12) Patent Application Publication
(10) Pub. No.: US 2025/0383791 A1
(43) Pub. Date: Dec. 18, 2025

(54) TEMPERATURE BASED POWER INDICATION

(71) Applicant: Micron Technology, Inc., Boise, ID (US)

(72) Inventors: Liang Yu, Boise, ID (US); Jonathan S. Parry, Boise, ID (US)

(21) Appl. No.: 19/233,599

(22) Filed: Jun. 10, 2025

Related U.S. Application Data
(60) Provisional application No. 63/659,763, filed on Jun. 13, 2024.

(51) Int. Cl. G06F 3/06

(52) U.S. Cl. CPC G06F 3/0625; G06F 3/0653; G06F 3/0673

(57) ABSTRACT

Methods, systems, and devices for temperature based power indication are described. A memory system may be configured to dynamically provide power based on measured temperatures of the memory dies. A controller of the memory system may be configured to provide a dynamic indication of power consumption associated with a measured temperature of a memory die. For example, the controller may identify a data transfer operation for a memory die and monitor a temperature of the memory die. The controller may determine an estimated power usage for the data transfer operation based on the temperature and skew information of the memory die. Then, the controller may transmit an indication of the estimated power usage to the memory dies, and the memory dies may adjust a power budget for performing other operations based on the estimated power usage.

### CROSS REFERENCE

The present application for patent claims priority to U.S. Patent Application No. 63/659,763 by Yu et al., entitled “TEMPERATURE BASED POWER INDICATION,” filed Jun. 13, 2024, which is assigned to the assignee hereof, and which is expressly incorporated by reference in its entirety herein.

### TECHNICAL FIELD

The following relates to one or more systems for memory, including temperature based power indication.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports temperature based power indication in accordance with examples as disclosed herein.

FIG. 2 shows an example of a system that supports temperature based power indication in accordance with examples as disclosed herein.

FIG. 3 shows an example of a memory system that supports temperature based power indication in accordance with examples as disclosed herein.

FIG. 4 shows an example of a process flow that supports temperature based power indication in accordance with examples as disclosed herein.

FIG. 5 shows a block diagram of a memory system that supports temperature based power indication in accordance with examples as disclosed herein.

FIG. 6 shows a flowchart illustrating a method or methods that support temperature based power indication in accordance with examples as disclosed herein.

### DETAILED DESCRIPTION

Some memory systems may include memory dies configured to operate under various conditions (e.g., environmental conditions). In some cases, temperature variations of the memory system may affect power consumption of the memory system during access operations at the memory dies. For example, relatively high temperatures of the memory dies may cause power leakage (e.g., current leakage) while providing power to the memory dies during one or more access operations at the relatively high temperatures. In some such examples, to account for performing the one or more access operations at the relatively high temperatures (e.g., associated with the power leakage), the memory system may budget for a relatively higher power consumption (e.g., compared to power associated with low temperature access operations). In some cases, the memory system may assume the temperature is relatively high when budgeting for the power consumption (e.g., for performing access operations at the memory dies), such that temperature variations of the memory system may not affect an ability to successfully perform the access operations. However, budgeting for relatively higher power consumption when the temperature is relatively low (e.g., and the power leakage is similarly low), may cause the memory system to allocate less power for other operations of the memory system.

In accordance with examples as described herein, the memory system may be configured to dynamically budget for power consumption associated with access operations based on measured temperatures of the memory dies. A controller of the memory system may be configured to provide a dynamic indication of power consumption associated with a measured temperature of a memory die. For example, the controller may identify a data transfer operation (e.g., an access operation) for a memory die and monitor a temperature of the memory die. The controller may determine an estimated power usage for the data transfer operation based on the temperature of the memory die. Then, the controller may transmit an indication of the estimated power usage to the memory dies, and the memory dies may adjust a power budget for performing other operations based on the estimated power usage. Dynamically adjusting power usage associated with data transfer operations may allow additional power to be allocated for the access operations without exceeding a total power budget.

In addition to applicability in memory systems as described herein, techniques for temperature based power indication may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by dynamically adjusting power consumption for performing access operations at a memory system, which may decrease power consumption and improve user experience, among other benefits.

In addition to applicability in memory systems as described herein, techniques for temperature based power indication may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by dynamically adjusting power consumption for performing access operations at a memory system, which may decrease power consumption, resulting in lowered power emissions, and extending the life of electronic devices, thereby reducing electronic waste, among other benefits.

Features of the disclosure are illustrated and described in the context of systems, devices, and circuits. Features of the disclosure are further illustrated and described in the context of memory systems, process flows, and flowcharts.

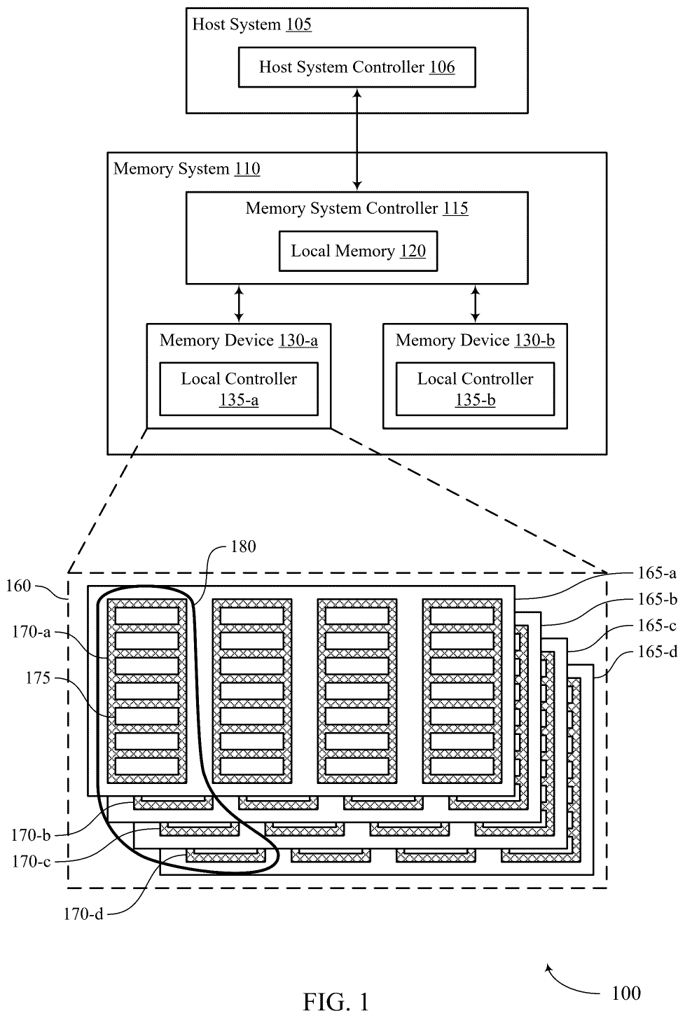

FIG. 1 shows an example of a system 100 that supports temperature based power indication in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In accordance with examples as described herein, the memory system 110 may be configured to dynamically budget for power consumption associated with data transfer operations based on measured temperatures of the memory devices 130 (e.g., memory dies). The memory system controller 115 may be configured to provide a dynamic indication of power consumption associated with a measured temperature of the memory device 130-a. For example, the memory system controller 115 may identify a data transfer operation (e.g., data transfer for an access operation) for the memory device 130-a and monitor a temperature of the memory device 130-a. The memory system controller 115 may determine an estimated power usage for the data transfer operation based on the temperature of the memory device 130-a. Then, the memory system controller 115 may transmit an indication of the estimated power usage to the memory devices 130, and the memory devices 130 may adjust a power budget for performing other operations (e.g., internal operations related to access operations) based on the estimated power usage. Dynamically adjusting power usage associated with data transfer operations may allow additional power to be allocated for the other operations related to access operations without exceeding a total power budget, among other advantages.

The system 100 may include any quantity of non-transitory computer readable media that support temperature based power indication. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

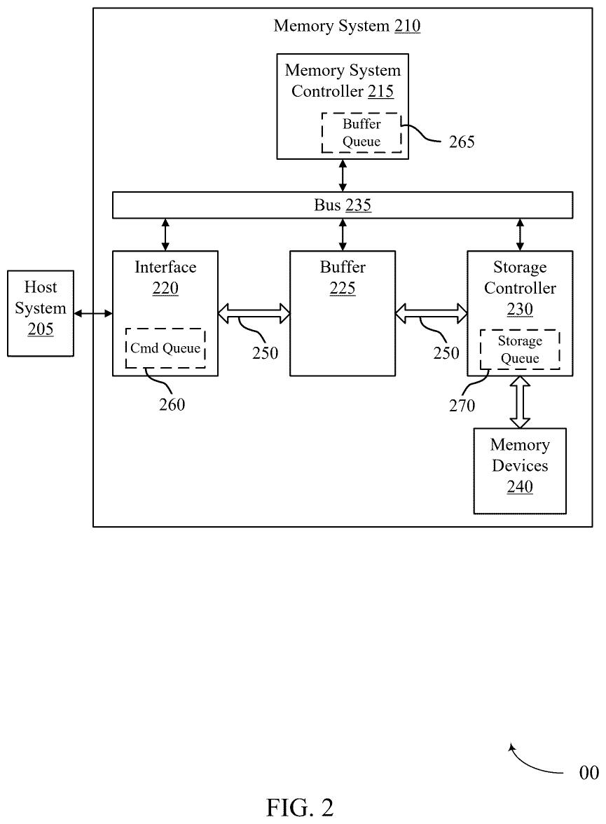

FIG. 2 shows an example of a system 200 that supports temperature based power indication in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

In accordance with examples as described herein, the memory system 210 may be configured to dynamically budget for power consumption associated with data transfer operations based on measured temperatures of the memory devices 240 (e.g., memory dies). The memory system controller 215 may be configured to provide a dynamic indication of power consumption associated with a measured temperature of the memory device 240. For example, the memory system controller 215 may identify a data transfer operation (e.g., data transfer for an access operation) for the memory device 240 and monitor a temperature of the memory device 240. The memory system controller 215 may determine an estimated power usage (e.g., at the memory device 240) for the data transfer operation based on the temperature of the memory device 240. Then, the memory system controller 215 may transmit an indication of the estimated power usage to the memory devices 240, and the memory devices 240 may adjust a power budget for performing other operations based on the estimated power usage. Dynamically adjusting power usage associated with access operations may allow additional power to be allocated for the access operations without exceeding a total power budget, among other advantages.

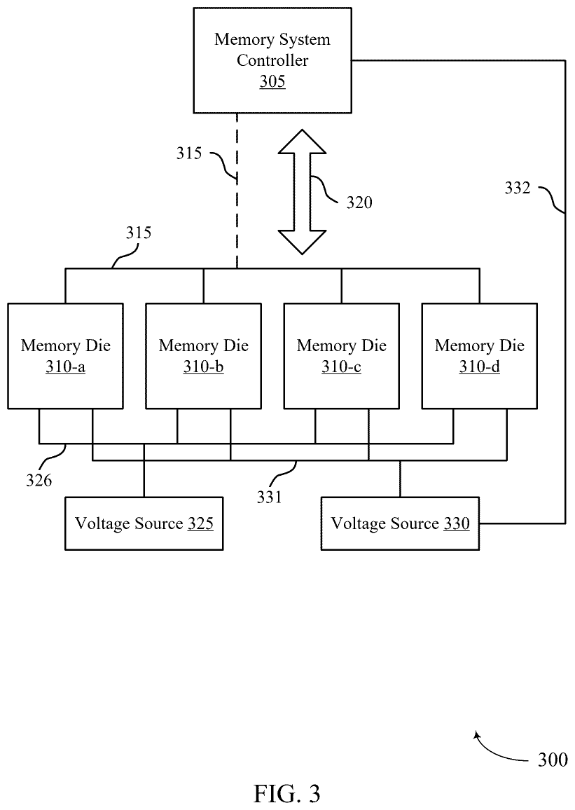

FIG. 3 shows an example of a memory system 300 that supports temperature based power indication in accordance with examples as disclosed herein. The memory system 300 may implement aspects or operations of a system, which may be an example of a system 100 or a system 200, as described with reference to FIGS. 1 and 2, respectively. For example, the memory system 300 may be an example of a memory system 110 or a memory system 210, as described with reference to FIGS. 1 and 2, respectively. The memory system 300 may be configured to dynamically allocate power for data transfer operations based on temperatures of memory dies 310.

The memory system 300 may include a memory system controller 305, which may be an example of a memory system controller 115 or a memory system controller 215, as described with reference to FIGS. 1 and 2, respectively. The memory system controller 305 may be configured to control operations of the memory system 300, such that the memory system controller 305 may facilitate data transfer operations and access operations at the memory system 300 as in a managed NAND (mNAND) system. In some cases, the memory system controller 305 may be configured to communicate with a host system.

The memory system 300 may include memory dies 310, which may be examples of memory devices 130 or memory devices 240, as described with reference to FIGS. 1 and 2, respectively. For example, the memory system 300 may include memory die 310-a, memory die 310-b, memory die 310-c, and memory die 310-d. Though the memory system 300 is illustrated with four memory dies 310, it should be understood that the memory system 300 may implement other quantities of memory dies 310. The memory dies 310 may be NAND dies, such that the memory dies 310 may each include one or more memory arrays (e.g., NAND arrays) of memory cells (e.g., NAND cells). The memory dies 310 may each include a local controller which may control internal operations of the memory die, and may support communication between the memory dies 310.

The memory system controller 305 may be coupled with an interface 320 configured to convey information (e.g., data), commands (e.g., write requests, read requests), and indications. In some cases, the interface 320 may be an open NAND flash interface (ONFI). The memory dies 310 may be coupled with the interface 320, such that the memory system controller 305 may be configured to communicate with the memory dies 310 via the interface 320. For example, the memory system controller 305 may be configured to transmit information, commands, and indications to the memory dies 310 on the interface 320. In some cases, the interface 320 may be coupled with each of the memory dies 310, or in some cases the interface 320 may include a separate interface 320 for each of the memory dies 310. The memory dies 310 may each be coupled with a serial bus 315, such that the memory dies 310 may be configured to communicate with each other via the serial bus 315. In some examples, the memory system controller 305 may be coupled with the serial bus 315, such that the memory system controller 305 may communicate with the memory dies 310 via the serial bus 315.

The memory system 300 may include a voltage source 325 and a voltage source 330. In some examples, the voltage source 325 may be an example of a VCC voltage source, and the voltage source 330 may be an example of a VCCQ voltage source. The voltage source 325 and the voltage source 330 may be configured to supply voltages to components of the memory system 300. In some examples, the voltage source 325 and the voltage source 330 may be configured to supply different voltage levels to the memory system 300. The voltage source 325 may be coupled with the memory dies 310 and configured to supply power to the memory dies 310. For example, the voltage source 325 may be coupled with internal circuitry (e.g., local controllers, memory arrays, array decoders, sense amplifiers, datapath circuits) of the memory dies 310 via one or more power rails 326 configured to transfer power between the voltage source 325 and the memory dies 310. In some examples, the voltage source 325 may be associated with providing power for internal operations of the memory dies, such as internal array operations and data manipulation operations. For example, the voltage source 325 may provide power for programming data, reading data, buffering data, preparing data for transmission, or error checking, among other operations. In some examples, the voltage source 325 may be configured to provide power for performing data transfer operations between the memory system controller 305 and the memory dies 310 (e.g., power used by the memory dies 310 to prepare or process data for data transfer operations). In some such examples, the one or more power rails 326 may include a singular power rail 326 shared between the memory dies 310, or a quantity of power rails 326 extending between the voltage source 325 and each of the memory dies 310.

The voltage source 330 may be coupled with the memory dies 310 and the memory system controller 305, and may be configured to supply power to the memory dies 310 and the memory system controller 305. For example, the voltage source 330 may be coupled with input/output (I/O) drivers (e.g., configured to communicate information over data channels) associated with the memory dies 310 via one or more power rails 331. In some such examples, the one or more power rails 331 may include a singular power rail 331 shared between the memory dies 310, or a quantity of power rails 331 extending between the voltage source 330 and each of the memory dies 310. Further, the voltage source 330 may be coupled with the memory system controller 305 via a power rail 332. In some cases, the voltage source 330 may provide power for part of the data transfer operations between the memory system controller 305 and the memory dies 310. For example, the voltage source 330 may provide power to I/O drivers for transferring data between the memory system controller 305 and the memory dies 310.

In some cases, the memory dies 310 may be configured to allocate power for operations of the memory dies 310. For example, the memory dies 310 may be configured to communicate via the serial bus 315 to determine appropriate power for internal operations of the memory dies 310. The memory dies 310 may communicate via the serial bus 315 to share power provided by the voltage source 325 for performing operations (e.g., the memory dies 310 may allocate power for performing the operations). For example, a memory die 310 may determine how much power from the voltage source 325 may be used for performing a first operation and may indicate to the other memory dies 310 the power used for the first operation, such that a remaining amount of power may be allocated for other operations by the other memory dies 310. In some such cases, each memory die 310 may be configured to notify the other memory die 310 prior to performing the internal operations, such that a remaining amount of the total power budget may be determined. In some examples, the memory dies 310 may allocate the power for performing the internal operations such that the power consumed may not exceed the total power budget. In some examples, the memory dies 310 may communicate via indications (e.g., tokens) associated with power usage for respective operations of the memory dies 310.

In some cases, the memory system controller 305 may be configured to manage data storage of the memory dies 310. For example, the memory system controller 305 may be configured to perform a data transfer operation with the memory dies 310, in which data may be transferred from the memory system controller 305 to a target memory die 310. In some cases, the memory system controller 305 may be configured to determine an estimated power usage for the data transfer operation from the power source 325, such that the memory system controller 305 may identify the quantity of the total power budget associated with performing the data transfer operation. For example, the memory system controller 305 may determine the estimated power usage based on the quantity of data associated with the data transfer operation. The memory system controller 305 may be configured to communicate the estimated power usage to the memory dies 310, such that the memory dies 310 may allocate power from the total power budget for performing the data transfer operation. The memory system controller 305 may indicate the estimated power usage to one of the memory dies over interface 320 (e.g., via an ONFI command), or may indicate the power usage to the memory dies 310 over the serial bus 315.

In some cases, the memory system controller 305 may be configured to monitor the temperature of the memory dies 310 and dynamically adjust power estimation for the memory dies 310. For example, the memory system controller 305 may be configured to receive the temperature of one or more memory dies 310 for one or more data transfer operations, and determine an amount of power to be used from the power source 325 associated with performing the one or more data transfer operations based on the temperature. The memory system controller 305 may be configured to identify estimated power usages associated with various temperature ranges of the memory dies 310 and determine the estimated power usage for the temperature received from the one or more memory dies 310. In some cases, the memory system controller 305 may determine the estimated power usage based on skew information associated with the memory dies. The memory system controller 305 may be configured to transmit an indication of the estimated power usage to one or more of the memory dies 310. For example, the memory system controller 305 may transmit the indication of the estimated power usage via the serial bus 315 or the interface 320. After receiving the indication, the memory dies 310 may be configured to allocate power for the operations of the memory dies 310 based on the estimated power usage associated with the one or more data transfer operations. The memory dies 310 may be configured to allocate portions of the total power budget associated with the power supplied by the voltage source 325, such that the data transfer operation may be performed using the estimated power usage and other operations of the memory dies 310 may be performed using portions of the remaining total power budget.

Implementing the memory system controller 305 for dynamically allocating power for data transfer operations of the memory dies 310 may prevent excess power from being allocated for the performing the data transfer operation, among other advantages. For example, allocating the power based on a measured temperature of the memory dies 310 may enable appropriate power to be provided to the memory dies 310, such that excess power may be conserved from the total power budget, thereby allowing internal data operation of the memory dies 310 to use more of the total power budget, among other advantages.

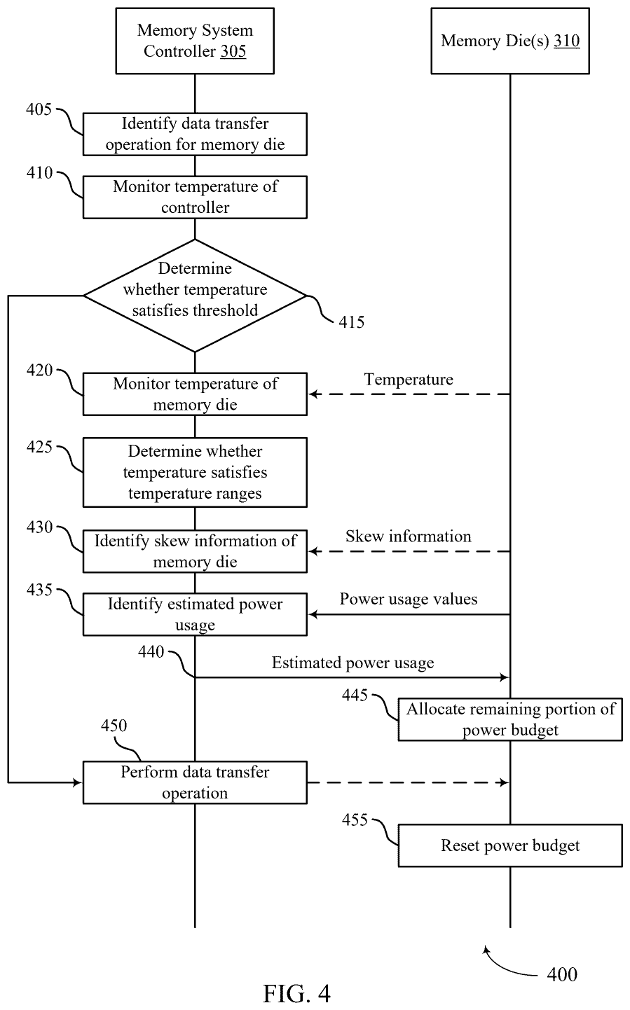

FIG. 4 shows an example of a process flow 400 that supports temperature based power indication in accordance with examples as disclosed herein. The process flow 400 may illustrate aspects or operations of a memory system, which may be an example of a memory system 110, a memory system 210, or a memory system 300, as described with reference to FIGS. 1 through 3, respectively. For example, some processes or operations of the process flow 400 may be implemented at a memory system controller 305 and memory dies 310, as described with reference to FIG. 3. The process flow 400 illustrates operations associated with dynamically allocating power for data transfer operations based on temperatures of the memory dies 310.

In the following description of the process flow 400, the methods, techniques, processes, and operations may be performed in different orders or at different times. Further, some operations may be left out of the process flow 400, or other operations may be added to the process flow 400. Aspects of the process flow 400 may be facilitated by the memory system controller 305 or an external controller of the memory system 300.

At 405, a data transfer operation of a memory die 310 may be identified. For example, the memory system controller 305 may identify the data transfer operation for a target memory die 310 (e.g., a memory die 310-a) of the memory dies 310. The data transfer operation may include transferring data between the target memory die 310 and the memory system controller 305, as in an access operation of the target memory die 310. For example, the data transfer operation may include transferring data from the memory system controller 305 to the target memory die 310 as part of an access operation (e.g., a read operation, a write operation) initiated by a host command. In other examples, the data transfer operation may include transferring data from the memory system controller 305 to the target memory die 310 or between the memory dies 310 as part of other operations managed by the controller, such as folding operations or garbage collection operations. In some examples, the memory system controller 305 may identify the data transfer operation based on identifying a queued access operation.

At 410, a temperature of the memory system controller 305 may be monitored. For example, the memory system controller 305 may monitor the temperature of the memory system controller 305. In some cases, the memory system controller 305 may monitor the temperature by reading out a value of a temperature sensor at the memory system controller 305.

At 415, the memory system controller 305 may determine whether the temperature satisfies a threshold. The memory system controller 305 may compare the temperature of the memory system controller 305 to the threshold and determine whether the temperature satisfies the threshold. In some examples, the threshold may be a temperature threshold, such as 65° C. In some cases, the memory system controller 305 may determine the temperature satisfies (e.g., is greater than, is equal to or greater than) the threshold, and the process flow 400 may continue to operation 420. In other cases, the memory system controller 305 may determine the temperature does not satisfy (e.g., is less than, is less than or equal to) the threshold, and the process flow 400 may continue to operation 450.

At 420, a temperature of the memory die 310 may be monitored. For example, the memory system controller 305 may monitor the temperature of the target memory die 310. In some cases, monitoring the temperature of the target memory die 310 may include monitoring the temperature of each of the memory dies 310. In some cases, the memory system controller 305 may monitor the temperature by retrieving a value from a temperature sensor associated with the target memory die 310. For example, the memory system controller 305 may read out the value of the temperature sensor to determine the temperature of the memory die 310. In other cases, the memory system controller 305 may transfer a request for the temperature to the memory dies, and the memory dies 310 may transmit respective indications of their respective temperatures to the memory system controller 305. In some examples, the memory dies 310 may read out the value from the temperature sensor prior to transmitting the indication of the temperature to the memory system controller 305.

At 425, a temperature range associated with the temperature may be determined. The memory system controller 305 may compare the temperature of the memory die 310 to a quantity of temperature ranges, to determine which temperature range the temperature of the memory die 310 is associated with. For example, the memory system controller 305 may determine whether the temperature is associated with a first temperature range, a second temperature range, or a third temperature range. The first temperature range may be associated with a quantity of temperatures below a first threshold (e.g., 65° C.), the second temperature range may be associated with a quantity of temperatures between the first threshold and a second threshold (e.g., 85° C.), and the third temperature range may be associated with a quantity of temperatures above the second threshold. It should be understood that the temperature ranges may not be limited to three temperature ranges, the temperature may be compared to other quantities of temperature ranges, in some cases.

The memory system controller 305 may use a table of the temperature ranges to determine which temperature range the temperature is associated with. In some such cases, the memory system controller 305 may store the temperature ranges in a table at local memory of the memory system controller 305. For example, the table may be configured during startup of the memory system 300, and stored at the memory system controller 305. In other cases, the table may be stored within the memory dies 310, and the memory system controller 305 may retrieve (e.g., request and receive) the table from the memory dies 310. For example, the table may be stored in a non-volatile memory array associated with the memory dies 310. In some such cases, after retrieving the table, the memory system controller 305 may identify the temperature range associated with the temperature of the memory die 310 using the table. In some cases, the table may include power usage information associated with each temperature range, such that identifying the temperature range may identify an estimated power usage associated with the temperature range. In some examples, the power usage information may be based on a quantity of data, such that identifying the estimated power usage may be based on the quantity of data associated with the data transfer operation.

At 430, skew information of the memory die 310 may be monitored. For example, the memory system controller 305 may identify the skew information of the target memory die 310. The skew information may be data path skew information indicative of a strength of transistors in a data path associated with the memory die 310. For example, relatively strong transistors (e.g., a process corner having fast N-channel transistors and fast P-channel transistors, which may be called a fast-fast process corner) may have relatively higher drive strength along the data path. In some such examples, higher drive strength may be associated with relatively higher power consumption. In other examples, relatively weak transistors (e.g., a process corner having slow N-channel transistors and slow P-channel transistors, which may be called a slow-slow process corner) may have relatively lower drive strength along the data path. In some such examples, lower drive strength may be associated with relatively lower power consumption. In some cases, the memory system controller 305 may identify the skew information based on reading out a value corresponding to the skew information of the memory die 310. In some such cases, the memory system controller 305 may transfer a request for the skew information to the memory dies, and the memory dies 310 may transmit the indication of the skew information to the memory system controller 305.

At 435, an estimated power usage may be identified. For example, the memory system controller 305 may identify the estimated power usage of the data transfer operation based on the temperature of the memory die 310 and the skew information associated with memory die 310. In some examples, the memory system controller 305 may identify the estimated power usage based on the quantity of data associated with data transfer operation. The memory system controller 305 may identify the estimated power usage from a quantity of estimated power usage values, where each estimated power usage value is associated with a respective temperature range and respective skew information. The memory system controller 305 may identify the temperature range associated with the temperature of the memory die 310, and the skew information associated with the memory die 310, then identify the estimated power usage value associated with the temperature range and the skew information. In some cases when the temperature is relatively higher, the estimated power usage value may indicate relatively higher power consumption; whereas when the temperature is relatively lower, the estimated power usage value may indicate relatively lower power consumption. In some cases when the skew information indicates relatively higher drive strength, the estimated power usage value may indicate relatively higher power consumption; whereas when the drive strength is relatively lower, the estimated power usage value may indicate relatively lower power consumption. In some cases, the memory system controller 305 may use the table to determine the estimated power usage. For example, the table may include the estimated power usage values associated with the respective temperature ranges and the skew information. The memory system controller 305 may identify the estimated power usage value from the table.

At 440, the estimated power usage may be transmitted to one or more of the memory dies 310. The memory system controller 305 may transmit an indication of the estimated power usage to the memory dies 310 based on identifying the estimated power usage. In some cases, the memory system controller 305 may transmit the indication of the estimated power usage via an interface (e.g., an interface 320) coupled with the memory dies 310. For example, the memory system controller 305 may transmit the indication to a memory die 310 of the memory dies 310 via the interface, and the memory die 310 may communicate the indication to the other memory dies 310 via a communication link connecting the memory dies 310 (e.g., serial bus 315). In other cases, the memory system controller 305 may transmit the indication of the estimated power usage via the communication link (e.g., serial bus 315) coupled with the memory dies 310. For example, the memory system controller 305 may transmit the indication to a memory die 310 of the memory dies 310 via the interface 320, and the memory die 310 may communicate the indication to the other memory dies 310 via the serial bus. In some examples, the memory system controller 305 may transmit the indication to the target memory die 310, or the memory system controller 305 may transmit the indication to all of the memory dies 310 (e.g., via the interface 320, via the serial bus 315).

At 445, a remaining portion of a power budget may be allocated. For example, the memory dies 310 may be configured to allocate a power budget for performing operations (e.g., internal operations) of the memory dies 310. In some cases, the memory dies 310 may be provided with a total power budget for performing operations of the memory dies 310, and the memory dies 310 may reserve portions of the total power budget associated with each operation of the memory dies 310 by communicating their power usage for an upcoming time interval. The memory dies 310 may allocate the power budget based on the estimated power usage. For example, the indication of the estimated power usage communicated at 440 may reserve an amount of power corresponding to the estimated power usage, and the memory dies 310 may allocate the remaining power from the total power budget (e.g., minus the estimated power usage) for performing other operations of the memory dies 310, such that performing the data transfer operation and the other operations does not exceed the total power budget.

At 450, the data transfer operation may be performed. In some cases, the data transfer operation may be performed between the target memory die 310 and the memory system controller 305, as in an access operation of the target memory die 310. The data transfer operation may be performed using the estimated power usage. For example, the memory dies 310 may perform the data transfer operation and other operations using the total power budget based on accounting for the estimated power usage. In some cases, the memory dies 310 may perform other operations using the remaining power from the total power budget based on performing the data transfer operation. In some such cases, the other operations may be performed concurrently with performing the data transfer operation.

At 455, the power usage may be reset. The memory dies 310 may reset the power usage based on performing the data transfer operation and/or the other operations of the memory dies 310. For example, the power usage may be reset such that the available power budget is equivalent to a value prior to allocating the estimated power usage (e.g., the total power budget). In some cases, resetting the power usage may include transferring an indication from the memory system controller 305 to the memory dies 310 that the data transfer operation has been completed and the memory dies 310 should no longer allocate the estimated power usage from the total power budget for performing the data transfer operation. In some such cases, after resetting the power usage, the memory system controller 305 may be configured to determine the estimated power usage for a future data transfer operation.

Implementing the process flow 400 for dynamically allocating power for data transfer operations of the memory dies 310 may prevent excess power from being allocated for the performing the data transfer operation, among other advantages. For example, allocating the power based on a measured temperature of the memory dies 310 may enable appropriate power to be provided to the memory dies 310, such that excess power may be conserved from the total power budget, thereby allowing internal data operation of the memory dies 310 to use more of the total power budget, among other advantages.

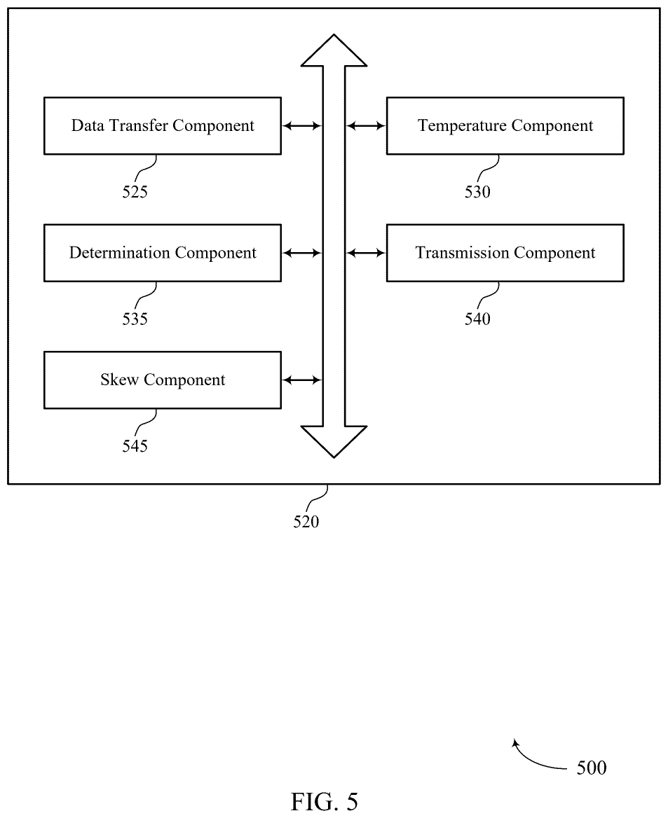

FIG. 5 shows a block diagram 500 of a memory system 520 that supports temperature based power indication in accordance with examples as disclosed herein. The memory system 520 may be an example of aspects of a memory system as described with reference to FIGS. 1 through 4. The memory system 520, or various components thereof, may be an example of means for performing various aspects of temperature based power indication as described herein. For example, the memory system 520 may include a data transfer component 525, a temperature component 530, a determination component 535, a transmission component 540, a skew component 545, or any combination thereof. Each of these components, or components of subcomponents thereof (e.g., one or more processors, one or more memories), may communicate, directly or indirectly, with one another (e.g., via one or more buses).

The data transfer component 525 may be configured as or otherwise support a means for identifying, by the controller, a data transfer operation associated with a memory die of a plurality of memory dies, where the plurality of memory dies are associated with a power budget for a first power supply of the memory system. The temperature component 530 may be configured as or otherwise support a means for receiving a first indication of a temperature of the memory die in response to identifying the data transfer operation. The determination component 535 may be configured as or otherwise support a means for identifying an estimated power usage from the first power supply associated with performing the data transfer operation in response to identifying a temperature range of one or more temperature ranges corresponding to the temperature of the memory die. The transmission component 540 may be configured as or otherwise support a means for transmitting a second indication of the estimated power usage to one or more of the plurality of memory dies.

In some examples, the data transfer component 525 may be configured as or otherwise support a means for performing the data transfer operation in response to transmitting the second indication of the estimated power usage.

In some examples, the transmission component 540 may be configured as or otherwise support a means for transmitting a third indication to the one or more of the plurality of memory dies resetting the estimated power usage to the first power supply in response to completion of performing the data transfer operation.

In some examples, the determination component 535 may be configured as or otherwise support a means for determining whether a temperature of the controller satisfies a temperature threshold, where receiving the first indication is in response to determining that the temperature of the controller satisfies the temperature threshold.

In some examples, the skew component 545 may be configured as or otherwise support a means for identifying skew information associated with the memory die, where identifying the estimated power usage is in response to identifying the skew information associated with the memory die.

In some examples, the transmission component 540 may be configured as or otherwise support a means for transmitting a request for the temperature of the memory die to the memory die, where receiving the first indication is in response to transmitting the request.

In some examples, to support receiving the first indication of the temperature, the temperature component 530 may be configured as or otherwise support a means for monitoring an output of a temperature sensor associated with the memory die.

In some examples, the determination component 535 may be configured as or otherwise support a means for receiving one or more estimated power usage values corresponding to the one or more temperature ranges, where identifying the estimated power usage is in response to receiving an estimated power usage value associated with the temperature range.

In some examples, the power budget is associated with access operations of the plurality of memory dies.

In some examples, transmitting the second indication of the estimated power usage includes transmitting the second indication via a serial bus coupled with each of the plurality of memory dies.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

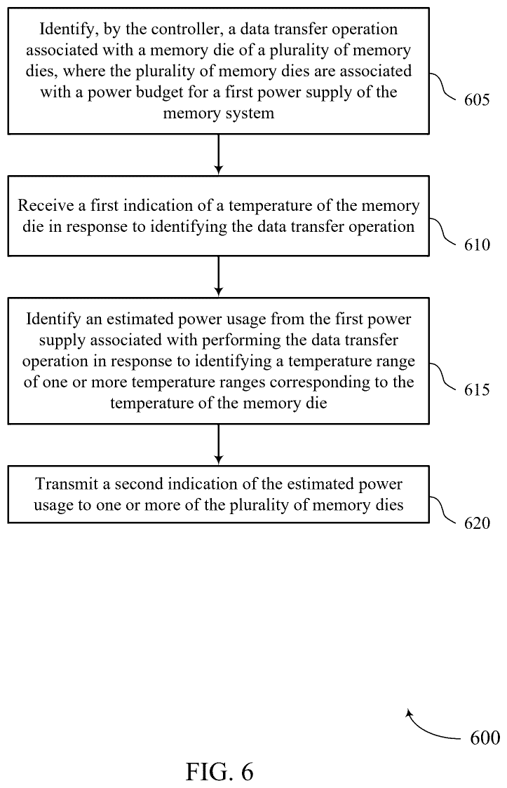

FIG. 6 shows a flowchart illustrating a method 600 that supports temperature based power indication in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include identifying, by the controller, a data transfer operation associated with a memory die of a plurality of memory dies, where the plurality of memory dies are associated with a power budget for a first power supply of the memory system. In some examples, aspects of the operations of 605 may be performed by a data transfer component 525 as described with reference to FIG. 5.

At 610, the method may include receiving a first indication of a temperature of the memory die in response to identifying the data transfer operation. In some examples, aspects of the operations of 610 may be performed by a temperature component 530 as described with reference to FIG. 5.

At 615, the method may include identifying an estimated power usage from the first power supply associated with performing the data transfer operation in response to identifying a temperature range of one or more temperature ranges corresponding to the temperature of the memory die. In some examples, aspects of the operations of 615 may be performed by a determination component 535 as described with reference to FIG. 5.

At 620, the method may include transmitting a second indication of the estimated power usage to one or more of the plurality of memory dies. In some examples, aspects of the operations of 620 may be performed by a transmission component 540 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for identifying, by the controller, a data transfer operation associated with a memory die of a plurality of memory dies, where the plurality of memory dies are associated with a power budget for a first power supply of the memory system; receiving a first indication of a temperature of the memory die in response to identifying the data transfer operation; identifying an estimated power usage from the first power supply associated with performing the data transfer operation in response to identifying a temperature range of one or more temperature ranges corresponding to the temperature of the memory die; and transmitting a second indication of the estimated power usage to one or more of the plurality of memory dies.

Aspect 2: The method, apparatus, or non-transitory computer-readable medium of aspect 1, further including operations, features, circuitry, logic, means, or instructions, or any combination thereof for performing the data transfer operation in response to transmitting the second indication of the estimated power usage.

Aspect 3: The method, apparatus, or non-transitory computer-readable medium of aspect 2, further including operations, features, circuitry, logic, means, or instructions, or any combination thereof for transmitting a third indication to the one or more of the plurality of memory dies resetting the estimated power usage to the first power supply in response to completion of performing the data transfer operation.

Aspect 4: The method, apparatus, or non-transitory computer-readable medium of any of aspects 1 through 3, further including operations, features, circuitry, logic, means, or instructions, or any combination thereof for determining whether a temperature of the controller satisfies a temperature threshold, where receiving the first indication is in response to determining that the temperature of the controller satisfies the temperature threshold.

Aspect 5: The method, apparatus, or non-transitory computer-readable medium of any of aspects 1 through 4, further including operations, features, circuitry, logic, means, or instructions, or any combination thereof for identifying skew information associated with the memory die, where identifying the estimated power usage is in response to identifying the skew information associated with the memory die.

Aspect 6: The method, apparatus, or non-transitory computer-readable medium of any of aspects 1 through 5, further including operations, features, circuitry, logic, means, or instructions, or any combination thereof for transmitting a request for the temperature of the memory die to the memory die, where receiving the first indication is in response to transmitting the request.

Aspect 7: The method, apparatus, or non-transitory computer-readable medium of any of aspects 1 through 6, where receiving the first indication of the temperature includes operations, features, circuitry, logic, means, or instructions, or any combination thereof for monitoring an output of a temperature sensor associated with the memory die.

Aspect 8: The method, apparatus, or non-transitory computer-readable medium of any of aspects 1 through 7, further including operations, features, circuitry, logic, means, or instructions, or any combination thereof for receiving one or more estimated power usage values corresponding to the one or more temperature ranges, where identifying the estimated power usage is in response to receiving an estimated power usage value associated with the temperature range.

Aspect 9: The method, apparatus, or non-transitory computer-readable medium of any of aspects 1 through 8, where the power budget is associated with access operations of the plurality of memory dies.

Aspect 10: The method, apparatus, or non-transitory computer-readable medium of any of aspects 1 through 9, where transmitting the second indication of the estimated power usage includes transmitting the second indication via a serial bus coupled with each of the plurality of memory dies.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 11: A memory system, including: a plurality of memory dies; and a controller coupled with the plurality of memory dies and configured to cause the memory system to: identify a data transfer operation associated with a memory die of the plurality of memory dies, where the plurality of memory dies are associated with a power budget for a first power supply of the memory system; receive a first indication of a temperature of the memory die in response to identifying the data transfer operation; identify an estimated power usage from the first power supply associated with performing the data transfer operation in response to identifying a temperature range of one or more temperature ranges corresponding to the temperature of the memory die; and transmit a second indication of the estimated power usage to one or more of the plurality of memory dies.

Aspect 12: The memory system of aspect 11, where the controller is further configured to cause the memory system to: perform the data transfer operation in response to transmitting the second indication of the estimated power usage.

Aspect 13: The memory system of aspect 12, where the controller is further configured to cause the memory system to: transmit a third indication to the one or more of the plurality of memory dies resetting the estimated power usage to the first power supply in response to completion of the data transfer operation.

Aspect 14: The memory system of any of aspects 11 through 13, where the controller is further configured to cause the memory system to: determine whether a temperature of the controller satisfies a temperature threshold, where receiving the first indication is in response to determining that the temperature of the controller satisfies the temperature threshold.

Aspect 15: The memory system of any of aspects 11 through 14, where the controller is further configured to cause the memory system to: identify skew information associated with the memory die, where identifying the estimated power usage is in response to identifying the skew information associated with the memory die.

Aspect 16: The memory system of any of aspects 11 through 15, where the controller is further configured to cause the memory system to: transmit a request for the temperature of the memory die to the memory die, where receiving the first indication is in response to transmitting the request.

Aspect 17: The memory system of any of aspects 11 through 16, where to receive the first indication of the temperature, the controller is further configured to cause the memory system to: monitor an output of a temperature sensor associated with the memory die.

Aspect 18: The memory system of any of aspects 11 through 17, where the controller is further configured to cause the memory system to: receive one or more estimated power usage values corresponding to the one or more temperature ranges, where identifying the estimated power usage is in response to receiving an estimated power usage value associated with the temperature range.

Another apparatus is described. The following provides an overview of aspects of the apparatus as described herein:

Aspect 19: A memory system, including: a plurality of memory dies; and a controller coupled with the plurality of memory dies and configured to cause the memory system to: identify a data transfer operation associated with a memory die of the plurality of memory dies, where the plurality of memory dies are associated with a power budget for a first power supply of the memory system; monitor a temperature of the memory die in response to identifying the data transfer operation; identify an estimated power usage from the first power supply associated with performing the data transfer operation in response to identifying a temperature range of one or more temperature ranges corresponding to the temperature of the memory die; transmit a second indication of the estimated power usage to one or more of the plurality of memory dies; and perform the data transfer operation in response to transmitting the second indication.

Aspect 20: The memory system of aspect 19, where the one or more of the plurality of memory dies are configured to: receive the second indication of the estimated power usage; and allocate a remaining portion of the power budget in excess of the estimated power usage for performing access operations associated with the plurality of memory dies in response to receiving the second indication.

Aspect 21: The memory system of aspect 20, where the one or more of the plurality of memory dies are configured to: indicate, to one or more other of the plurality of memory dies, the remaining portion of the power budget.

Aspect 22: The memory system of any of aspects 19 through 21, where the memory die is configured to cause the memory system to: transmit skew information associated with the memory die to the controller, where identifying the estimated power usage is in response to the controller receiving the skew information.

Aspect 23: The memory system of any of aspects 19 through 22, where the controller is further configured to cause the memory system to: determine whether a temperature of the controller satisfies a temperature threshold, where monitoring the temperature of the memory die is in response to determining that the temperature of the controller satisfies the temperature threshold.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
a plurality of memory dies; and
a controller coupled with the plurality of memory dies and configured to cause the memory system to:
identify a data transfer operation associated with a memory die of the plurality of memory dies, wherein the plurality of memory dies are associated with a power budget for a first power supply of the memory system;
receive a first indication of a temperature of the memory die in response to identifying the data transfer operation;
identify an estimated power usage from the first power supply associated with performing the data transfer operation in response to identifying a temperature range of one or more temperature ranges corresponding to the temperature of the memory die; and
transmit a second indication of the estimated power usage to one or more of the plurality of memory dies.

2. The memory system of claim 1, wherein the controller is further configured to cause the memory system to:
perform the data transfer operation in response to transmitting the second indication of the estimated power usage.

3. The memory system of claim 2, wherein the controller is further configured to cause the memory system to:
transmit a third indication to the one or more of the plurality of memory dies resetting the estimated power usage to the first power supply in response to completion of the data transfer operation.

4. The memory system of claim 1, wherein the controller is further configured to cause the memory system to:
determine whether a temperature of the controller satisfies a temperature threshold,
wherein receiving the first indication is in response to determining that the temperature of the controller satisfies the temperature threshold.

5. The memory system of claim 1, wherein the controller is further configured to cause the memory system to:
identify skew information associated with the memory die,
wherein identifying the estimated power usage is in response to identifying the skew information associated with the memory die.

6. The memory system of claim 1, wherein the controller is further configured to cause the memory system to:
transmit a request for the temperature of the memory die to the memory die,
wherein receiving the first indication is in response to transmitting the request.

7. The memory system of claim 1, wherein to receive the first indication of the temperature, the controller is further configured to cause the memory system to:
monitor an output of a temperature sensor associated with the memory die.

8. The memory system of claim 1, wherein the controller is further configured to cause the memory system to:
receive one or more estimated power usage values corresponding to the one or more temperature ranges,
wherein identifying the estimated power usage is in response to receiving an estimated power usage value associated with the temperature range.

9. A memory system, comprising:
a plurality of memory dies; and
a controller coupled with the plurality of memory dies and configured to cause the memory system to:
identify a data transfer operation associated with a memory die of the plurality of memory dies, wherein the plurality of memory dies are associated with a power budget for a first power supply of the memory system;
monitor a temperature of the memory die in response to identifying the data transfer operation;
identify an estimated power usage from the first power supply associated with performing the data transfer operation in response to identifying a temperature range of one or more temperature ranges corresponding to the temperature of the memory die;
transmit a second indication of the estimated power usage to one or more of the plurality of memory dies; and
perform the data transfer operation in response to transmitting the second indication.

10. The memory system of claim 9, wherein the one or more of the plurality of memory dies are configured to:
receive the second indication of the estimated power usage; and
allocate a remaining portion of the power budget in excess of the estimated power usage for performing access operations associated with the plurality of memory dies in response to receiving the second indication.

11. The memory system of claim 10, wherein the one or more of the plurality of memory dies are configured to:
indicate, to one or more other of the plurality of memory dies, the remaining portion of the power budget.

12. The memory system of claim 9, wherein the memory die is configured to cause the memory system to:
transmit skew information associated with the memory die to the controller,
wherein identifying the estimated power usage is in response to the controller receiving the skew information.

13. The memory system of claim 9, wherein the controller is further configured to cause the memory system to:
determine whether a temperature of the controller satisfies a temperature threshold,
wherein monitoring the temperature of the memory die is in response to determining that the temperature of the controller satisfies the temperature threshold.

14. A method by a controller of a memory system, the method comprising:
identifying, by the controller, a data transfer operation associated with a memory die of a plurality of memory dies, wherein the plurality of memory dies are associated with a power budget for a first power supply of the memory system;
receiving a first indication of a temperature of the memory die in response to identifying the data transfer operation;
identifying an estimated power usage from the first power supply associated with performing the data transfer operation in response to identifying a temperature range of one or more temperature ranges corresponding to the temperature of the memory die; and
transmitting a second indication of the estimated power usage to one or more of the plurality of memory dies.

15. The method of claim 14, further comprising:
performing the data transfer operation in response to transmitting the second indication of the estimated power usage.

16. The method of claim 15, further comprising:
transmitting a third indication to the one or more of the plurality of memory dies resetting the estimated power usage to the first power supply in response to completion of performing the data transfer operation.

17. The method of claim 14, further comprising:
determining whether a temperature of the controller satisfies a temperature threshold,
wherein receiving the first indication is in response to determining that the temperature of the controller satisfies the temperature threshold.

18. The method of claim 14, further comprising:
identifying skew information associated with the memory die,
wherein identifying the estimated power usage is in response to identifying the skew information associated with the memory die.

19. The method of claim 14, further comprising:
transmitting a request for the temperature of the memory die to the memory die,
wherein receiving the first indication is in response to transmitting the request.

20. The method of claim 14, wherein receiving the first indication of the temperature comprises:
monitoring an output of a temperature sensor associated with the memory die.

21. The method of claim 14, further comprising:
receiving one or more estimated power usage values corresponding to the one or more temperature ranges,
wherein identifying the estimated power usage is in response to receiving an estimated power usage value associated with the temperature range.

22. The method of claim 14, wherein the power budget is associated with access operations of the plurality of memory dies.

23. The method of claim 14, wherein transmitting the second indication of the estimated power usage comprises transmitting the second indication via a serial bus coupled with each of the plurality of memory dies.
